(19) United States
(12) Patent Application Publication
(10) Pub. No.: US 2018/0287162 A1
(43) Pub. Date: Oct. 4, 2018

(54) HIGH SURFACE AREA POROUS CARBON MATERIALS AS ELECTRODES

(71) Applicants: James M. Tour, Bellaire, TX (US); Wang Tuo, Houston, TX (US); Rodrigo Villegas Salvatierra, Houston, TX (US); Almaz S. Jalilov, Houston, TX (US)

(72) Inventors: James M. Tour, Bellaire, TX (US); Wang Tuo, Houston, TX (US); Rodrigo Villegas Salvatierra, Houston, TX (US); Almaz S. Jalilov, Houston, TX (US)

(73) Assignee: William Marsh Rice University, Houston, TX (US)

(21) Appl. No.: 15/766,261

(22) PCT Filed: Oct. 10, 2016
(86) PCT No.: PCT/US2016/056270

§ 371 Date: Jun. 11, 2018

Related U.S. Application Data
(60) Provisional application No. 62/238,849, filed on Oct. 8, 2015.

(51) Int. Cl. H01M 4/66; H01M 4/04; H01M 4/133; H01M 4/134; H01M 4/1393; H01M 4/1395; H01M 4/62; H01M 10/0525

(52) U.S. Cl. CPC H01M 4/663; H01M 4/0459; H01M 4/662; H01M 4/133; H01M 4/134; H01M 4/1393; H01M 4/0419; H01M 4/625; H01M 10/0525; H01M 4/0404; H01M 4/0409; H01M 4/0414; H01M 4/1395

(57) ABSTRACT

Embodiments of the present disclosure pertain to an electrode that includes: a porous carbon material; a metal (e.g., Li) associated with the porous carbon material; and a conductive additive (e.g., graphene nanoribbons) associated with the porous carbon material. The metal may be in the form of a non-dendritic or non-mossy coating on a surface of the porous carbon material. The electrodes may also be associated with a substrate, such as a copper foil. The electrodes may be utilized as anodes or cathodes in energy storage devices, such as lithium ion batteries. Additional embodiments pertain to energy storage devices that contain the electrodes of the present disclosure. Further embodiments pertain to methods of making the electrodes by associating porous carbon materials with a conductive additive, a metal, and optionally a substrate. The electrode may then be incorporated as a component of an energy storage device.

### CROSS-REFERENCE TO RELATED APPLICATIONS

This application claims priority to U.S. Provisional Patent Application No. 62/238,849, filed on Oct. 8, 2015. The entirety of the aforementioned application is incorporated herein by reference.

### STATEMENT REGARDING FEDERALLY SPONSORED RESEARCH

This invention was made with government support under Grant No. FA9550-14-1-0111, awarded by the U.S. Department of Defense; and Grant No. FA9550-12-1-0035, also awarded by the U.S. Department of Defense. The government has certain rights in the invention.

### BACKGROUND

Current metal-based electrode materials have numerous limitations, including the formation of dendrites during electrode operation, and limited electrochemical performance. Furthermore, current methods of making metal-based electrodes can be time-consuming and costly. Various aspects of the present disclosure address the aforementioned limitations.

### SUMMARY

In some embodiments, the present disclosure pertains to an electrode that includes: a porous carbon material; a metal associated with the porous carbon material; and a conductive additive associated with the porous carbon material. In some embodiments, the porous carbon material is an asphalt-based porous carbon material with a surface area of more than about 2,000 m²/g. In some embodiments, the metal includes lithium (Li) and the conductive additive includes graphene nanoribbons. In some embodiments, the metal is in the form of a non-dendritic or non-mossy coating on a surface of the porous carbon material. In some embodiments, the electrodes of the present disclosure are also associated with a substrate, such as a copper foil that serves as a current collector.

The electrodes of the present disclosure can serve various functions. For instance, in some embodiments, the electrodes of the present disclosure serve as an anode. In some embodiments, the electrodes of the present disclosure serve as a cathode. In some embodiments, the porous carbon materials in the electrodes of the present disclosure serve as a current collector while the metal serves as an active material.

In some embodiments, the electrodes of the present disclosure are utilized as components of an energy storage device, such as a lithium-ion battery. In additional embodiments, the present disclosure pertains to energy storage devices that contain the electrodes of the present disclosure.

In further embodiments, the present disclosure pertains to methods of making the electrodes of the present disclosure. In some embodiments, the methods of the present disclosure include a step of associating porous carbon materials with a conductive additive and a metal. In additional embodiments, the methods of the present disclosure also include a step of associating the porous carbon materials with a substrate. The methods of the present disclosure can also include a step of incorporating the electrode as a component of an energy storage device.

### DESCRIPTION OF THE FIGURES

FIG. 1 illustrates the formation of electrodes (FIG. 1A), a structure of a formed electrode (FIG. 1B), and the use of the formed electrodes in a battery (FIG. 1C).

FIG. 2 illustrates the preparation of porous carbon materials and their use as lithium (Li) anodes. FIG. 2A provides a scheme relating to the preparation of porous carbon from untreated gilsonite (uGil). FIG. 2B provides a charge/discharge profile for the preparation of uGil supported Li anodes (uGil-Li anodes). FIG. 2C provides a schematic illustration of uGil-Li anodes (right panel) in comparison to Li dendrites (left panel).

FIG. 3 provides data and images relating to various uGil-Li anodes. FIG. 3A provides the rate performance of uGil-Li anodes that contain graphene nanoribbon (GNRs) (uGil-GNR-Li anodes), where the Li:C ratio (i.e., mass ratio of Li to uGil-GNR) was 1:5. FIG. 3B provides charge/discharge profiles of uGil-GNR-Li anodes at different current densities. FIGS. 3C and 3D show top view scanning electron microscopy (SEM) images of uGil-GNR-Li anodes at different magnifications. FIGS. 3E-F show SEM images of the lithiated uGil-GNR-Li anode (FIG. 3E) and the delithiated uGil-GNR anode (FIG. 3F) after 30 discharge/charge cycles. Current densities are calculated using the mass of carbon (i.e., uGil and GNRs).

FIG. 4 provides additional data relating to the performance of uGil-GNR-Li anodes. FIG. 4A shows the cycling stability of a uGil-GNR-Li anode with a Li:C ratio of 1:5 at 1 A/g. FIG. 4B shows the cycling performance of a uGil-Li anode with a Li:C ratio of 1:2 at 2 A/g. FIG. 4C shows the cycling performance of a uGil-GNR-Li anode with a Li:C ratio of 1:1 at 2 A/g and 8 A/g. Current densities are calculated using the mass of carbon (i.e., uGil and GNRs, or uGil only).

FIG. 5 provides an internal resistance comparison of uGil-GNR-Li anodes and uGil-Li anodes. FIGS. 5A and 5B show Nyquist plots of the anodes in a lithiated state (FIG. 5A) and a delithiated state (FIG. 5B). FIGS. 5C-F provide comparisons of uGil-GNR-Li anodes and uGil-Li anodes on cycling performance at different current densities, including 0.5 A/g (FIG. 5C), 1 A/g (FIG. 5D), 2 A/g (FIG. 5E), and 4 A/g (FIG. 5F). Current densities are calculated using the mass of carbon (i.e., uGil and GNRs or uGil only).

FIG. 6 shows SEM images that compare the surface morphologies of uGil-Li anodes and uGil-GNR-Li anodes after 30 discharge/charge cycles. FIGS. 6A-B show SEM images of uGil-Li anodes after 30 cycles at 2 A/g. FIGS. 6C-D show uGil-Li anodes after 30 cycles at 4 A/g. FIGS. 6E-F show uGil-GNR-Li anodes after 30 cycles at 2 A/g. FIGS. 6G-H show uGil-GNR-Li anodes after 30 cycles at 4 A/g. Current densities are calculated using the mass of carbon (i.e., uGil and GNRs, or uGil only).

FIG. 7 shows the characterization of uGil-GNR-S cathodes and full Li—S batteries. FIG. 7A shows thermogravimetric analysis (TGA) curves of GNR-uGil-S and GNR-S composites. Also shown are the rate performance of full Li—S batteries with electrolyte solutions of 4 M LiFSI in DME (FIG. 7B) and 1 M LiFSI and 0.5 M LiNO₃ in DME (FIG. 7C).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Metals have been preferred components of electrode materials for many energy storage devices. For instance, lithium (Li) has been utilized for anode materials in Li-ion batteries (LIBs) since the 1990s. Moreover, the demand for energy storage devices (including LIBs) has increased in view of the growing market for portable electronic devices and electric vehicles.

However, a problem with the utilization of metals in electrode materials has been dendrite formation. For instance, although Li has high specific capacity (i.e., ˜3,860 mAh/g, which is 10 times higher than that of commercial graphite anodes), low electrochemical potential (i.e., −3.04 V), and high conductivity, the prevention of Li dendrite formation has remained a challenge for its practical applications. For instance, the formation of Li dendrites during the electrode charging process can damage the cycling performance of the anode and put it under the risk of explosions. In particular, the formed dendrites can readily penetrate separators and cause internal short circuits of batteries.

In order to make metal-based anodes safer to use, great efforts have been made to suppress dendritic growth. Such efforts can be divided into two major strategies: (i) constructing more stable and conductive solid-electrolyte interphase (SEI) layers; and (ii) developing a host material for metal (e.g., Li) plating and stripping.

The stabilization of SEI layers have been achieved through the use of high-concentration electrolytes, ionic liquids, and solid electrolytes. In addition, many host materials have been developed that act as substrates for uniformly distributing Li metal and suppressing dendrite formation. Such host materials have included hexagonal unstacked graphene, sparked reduced graphene oxide, and copper nanowire networks.

Moreover, Applicants have reported the use of three-dimensional seamless graphene-carbon nanotube hybrid materials (GCNT) as electrode materials that prevent Li dendrite growth. See, e.g., PCT/US2016/029184. However, the synthesis of the GCNT materials can be time-consuming and costly, thereby restricting the large-scale application of such materials.

As such, a need exists for the development of more stable and non-dendritic metal-based electrode materials that can be fabricated in a more facile and cost-effective manner. Various aspects of the present disclosure address the aforementioned need.

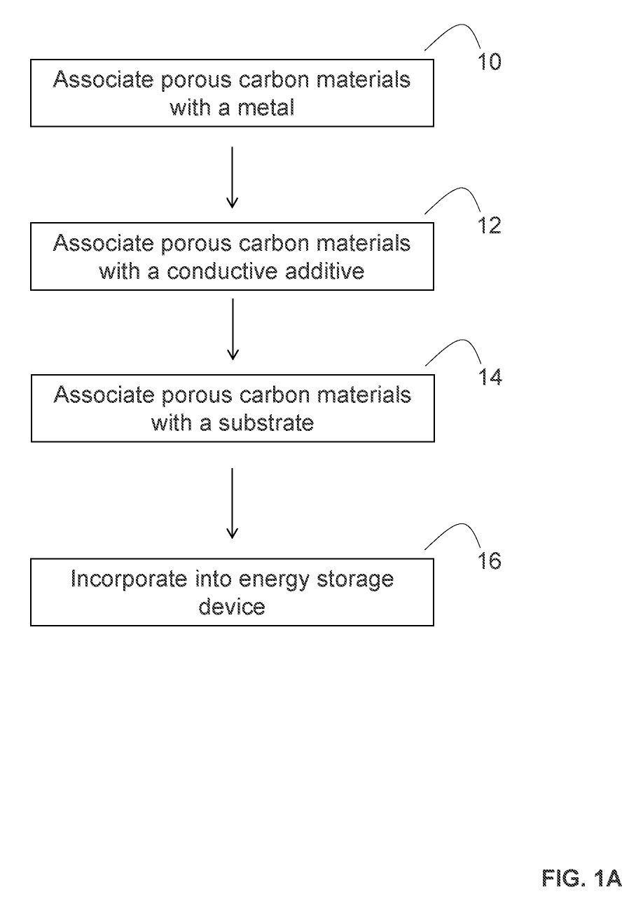

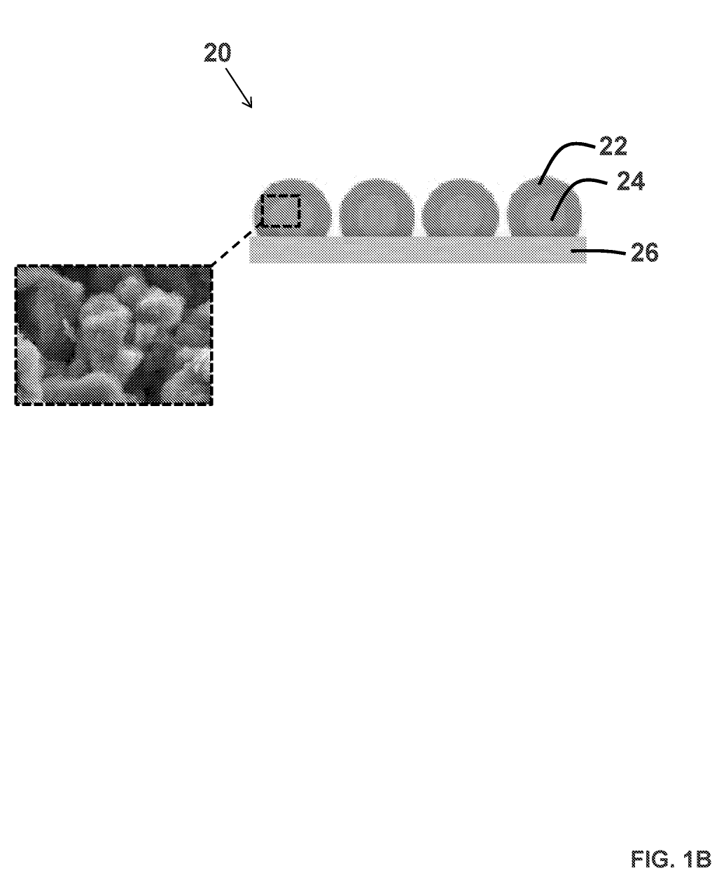

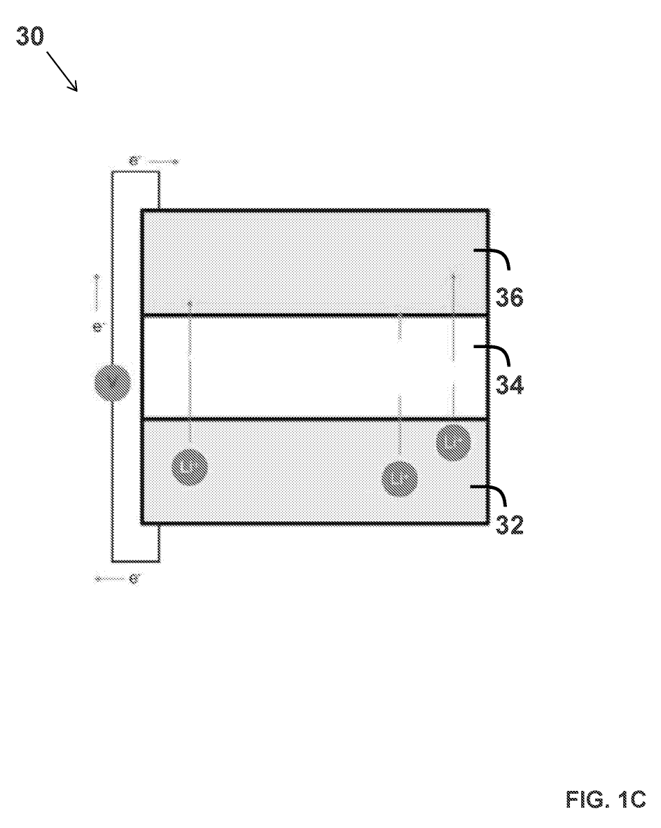

In some embodiments, the present disclosure pertains to methods of making electrodes that contain porous carbon materials. In some embodiments illustrated in FIG. 1A, the methods of the present disclosure include associating porous carbon materials with a metal (step 10); and a conductive additive (step 12). In some embodiments, the methods of the present disclosure also include a step of associating the porous carbon materials with a substrate (step 14). In some embodiments, the methods of the present disclosure also include a step of incorporating the formed electrode as a component of an energy storage device (step 16).

In additional embodiments, the present disclosure pertains to the formed electrodes. In some embodiments, the electrodes of the present disclosure include: porous carbon materials; a metal associated with the porous carbon materials; and a conductive additive associated with the porous carbon materials. In more specific embodiments illustrated in FIG. 1B, the electrodes of the present disclosure can be in the form of electrode 20, which includes metal 22, porous carbon materials 24, and substrate 26. In this embodiment, porous carbon materials 24 are in the form of particles. In addition, metal 22 is associated with porous carbon materials 24 in the form of non-dendritic or non-mossy films.

Further embodiments of the present disclosure pertain to energy storage devices that contain the electrodes of the present disclosure. For instance, as illustrated in FIG. 1C, the electrodes of the present disclosure can be utilized as components of battery 30, which contains cathode 32, anode 36, and electrolytes 34. In this embodiment, the electrodes of the present disclosure can serve as cathode 32 or anode 36.

As set forth in more detail herein, the present disclosure can utilize various types of porous carbon materials. Moreover, various metals and conductive additives may be associated with the porous carbon materials in various manners. Furthermore, the electrodes of the present disclosure can be utilized as components of various energy storage devices.

Porous Carbon Materials

The electrodes of the present disclosure can include various types of porous carbon materials. For instance, in some embodiments, the porous carbon materials of the present disclosure can include, without limitation, asphalt-based porous carbon materials, asphaltene-based porous carbon materials, anthracite-based porous carbon materials, coal-based porous carbon materials, coke-based porous carbon materials, biochar-based porous carbon materials, carbon black-based porous carbon materials, coal-based porous carbon materials, oil product-based porous carbon materials, bitumen-based porous carbon materials, tar-based porous carbon materials, pitch-based porous carbon materials, polymer-based porous carbon materials, protein-based porous carbon materials, carbohydrate-based porous carbon materials, cotton-based porous carbon materials, fat-based porous carbon materials, waste-based porous carbon materials, graphite-based porous carbon materials, melamine-based porous carbon materials, wood-based porous carbon materials, porous graphene, porous graphene oxide, high surface area active carbons (e.g., Maxsorb®), and combinations thereof.

In some embodiments, the porous carbon materials of the present disclosure are coal-based porous carbon materials. In some embodiments, the coal source includes, without limitation, bituminous coal, anthracitic coal, brown coal, and combinations thereof.

In some embodiments, the porous carbon materials of the present disclosure are protein-based porous carbon materials. In some embodiments, the protein source includes, without limitation, whey protein, rice protein, animal protein, plant protein, and combinations thereof.

In some embodiments, the porous carbon materials of the present disclosure are oil product-based porous carbon materials. In some embodiments, the oil products include, without limitation, petroleum oil, plant oil, and combinations thereof.

In some embodiments, the porous carbon materials of the present disclosure are waste-based porous carbon materials. In some embodiments, the waste can include, without limitation, human waste, animal waste, waste derived from municipality sources, and combinations thereof.

In some embodiments, the porous carbon materials of the present disclosure are asphalt-based porous carbon materials. In some embodiments, the asphalt sources include, without limitation, gilsonite asphalt, untreated gilsonite asphalt, naturally occurring asphalt, sulfonated asphalt, asphaltenes, and combinations thereof.

In some embodiments, the porous carbon materials of the present disclosure are derived from gilsonite asphalt, such as Versatrol HT, Versatrol M, and combinations thereof. In some embodiments, the porous carbon materials of the present disclosure are derived from sulfonated asphalt, such as Asphasol Supreme.

The porous carbon materials of the present disclosure can have various surface areas. For instance, in some embodiments, the porous carbon materials of the present disclosure have surface areas of more than about 2,000 m²/g. In some embodiments, the porous carbon materials of the present disclosure have surface areas of more than about 2,500 m²/g. In some embodiments, the porous carbon materials of the present disclosure have surface areas that range from about 2,000 m²/g to about 4,000 m²/g. In some embodiments, the porous carbon materials of the present disclosure have surface areas of more than about 4,000 m²/g.

The porous carbon materials of the present disclosure can also have various thicknesses. For instance, in some embodiments, the porous carbon materials of the present disclosure have a thickness ranging from about 10 μm to about 2 mm. In some embodiments, the porous carbon materials of the present disclosure have a thickness ranging from about 10 μm to about 1 mm. In some embodiments, the porous carbon materials of the present disclosure have a thickness ranging from about 10 μm to about 500 μm. In some embodiments, the porous carbon materials of the present disclosure have a thickness ranging from about 10 μm to about 100 μm. In some embodiments, the porous carbon materials of the present disclosure have a thickness of about 60 μm.

The porous materials of the present disclosure can also include various types of pores. For instance, in some embodiments, the pores in the porous materials of the present disclosure include, without limitation, nanopores, micropores, mesopores, macropores, and combinations thereof. In some embodiments, the pores in the porous materials of the present disclosure include micropores, mesopores, and combinations thereof. In some embodiments, the pores in the porous materials of the present disclosure include a mixture of micropores and mesopores.

The pores in the porous materials of the present disclosure can have various diameters. For instance, in some embodiments, the pores in the porous materials of the present disclosure include diameters ranging from about 0.1 nm to about 10 μm. In some embodiments, the pores in the porous materials of the present disclosure include diameters ranging from about 1 nm to about 100 nm. In some embodiments, the pores in the porous materials of the present disclosure include diameters ranging from about 1 nm to about 50 nm. In some embodiments, the pores in the porous materials of the present disclosure include diameters ranging from about 1 nm to about 10 nm.

In some embodiments, the pores in the porous materials of the present disclosure include diameters ranging from about 0.1 nm to about 5 nm. In some embodiments, the pores in the porous materials of the present disclosure include diameters of less than about 3 nm. In some embodiments, the pores in the porous materials of the present disclosure include diameters ranging from about 0.4 nm to about 3 nm.

In some embodiments, the pores in the porous materials of the present disclosure include diameters ranging from about 100 nm to about 10 μm. In some embodiments, the pores in the porous materials of the present disclosure include diameters ranging from about 1 μm to about 10 μm. In some embodiments, the pores in the porous materials of the present disclosure include diameters ranging from about 100 nm to about 1 μm.

The porous carbon materials of the present disclosure can also be in various forms. For instance, in some embodiments, the porous carbon materials of the present disclosure are in the form of particles (e.g., porous carbon material 24 in FIG. 1B). In some embodiments, the particles are in the form of an array of a carpet or a forest.

Metals

The porous carbon materials of the present disclosure may become associated with various metals. For instance, in some embodiments, the metals include, without limitation, alkali metals, alkaline earth metals, transition metals, post transition metals, rare-earth metals, metalloids, and combinations thereof.

In some embodiments, the metals include alkali metals. In some embodiments, the alkali metals include, without limitation, Li, Na, K, and combinations thereof. In some embodiments, the metals include alkaline earth metals. In some embodiments, the alkaline earth metals include, without limitation, Mg, Ca, and combinations thereof.

In some embodiments, the metals include transition metals. In some embodiments, the transition metals include, without limitation, Ti, V, Cr, Mn, Fe, Co, Ni, Cu, Zn, and combinations thereof.

In some embodiments, the metals include post transition metals. In some embodiments, the post transition metals include, without limitation, Al, Sn, Sb, Pb, and combinations thereof.

In some embodiments, the metals include metalloids. In some embodiments, the metalloids include, without limitation, B, Si, Ge, As, Te, and combinations thereof.

In some embodiments, the metals include, without limitation, Li, Na, K, Mg, Ca, Ti, V, Cr, Mn, Fe, Co, Ni, Cu, Zn, Al, Sn, Sb, Pb, B, Si, Ge, As, Te, and combinations thereof. In some embodiments, the metals include Li.

The metals of the present disclosure can become associated with porous carbon materials in various manners. For instance, in some embodiments, the metals can become associated with the porous carbon materials in situ during electrode operation. In some embodiments, the metals can become reversibly associated with the porous carbon materials. In some embodiments, the metals can become reversibly associated with the porous carbon materials during electrode operation by association during charging and dissociation during discharging.

In some embodiments, the metals of the present disclosure can become associated with porous carbon materials in a uniform manner. For instance, in some embodiments, the metals become associated with the porous carbon materials without forming dendrites. In some embodiments, the metals become associated with the porous carbon materials without forming aggregates (e.g., metal particulates or mossy aggregates). As such, in some embodiments, the metals associated with the porous carbon materials lack dendrites or mossy aggregates.

The metals of the present disclosure can become associated with various regions of porous carbon materials. For instance, in some embodiments, the metals become associated with surfaces of the porous carbon materials. In some embodiments, the metals are uniformly coated on surfaces of the porous carbon materials.

In some embodiments, the metals form non-dendritic or non-mossy coatings on the surfaces of the porous carbon materials. In some embodiments, the metals become infiltrated within the pores of the porous carbon materials.

In some embodiments, the metals are in the form of a layer on a surface of the porous carbon materials. In some embodiments, the metal becomes associated with the porous carbon materials in the form of a thin film. In some embodiments, the film is on a surface of the porous carbon materials (e.g., metal 22 in FIG. 1B). Additional modes of associations can also be envisioned.

Conductive Additives

The porous carbon materials of the present disclosure may also be associated with various conductive additives. For instance, in some embodiments, the conductive additives include, without limitation, graphene nanoribbons, graphene, reduced graphene oxide, graphoil, carbon nanotubes, carbon fibers, carbon black, polymers, and combinations thereof.

In some embodiments, the conductive additives include graphene nanoribbons. In some embodiments, the conductive additives include carbon nanotubes. In some embodiments, the carbon nanotubes include, without limitation, single-walled carbon nanotubes, few-walled carbon nanotubes, multi-walled carbon nanotubes, double-walled carbon nanotubes, triple-walled carbon nanotubes, multi-walled carbon nanotubes, ultra-short carbon nanotubes, small diameter carbon nanotubes, pristine carbon nanotubes, functionalized carbon nanotubes, and combinations thereof.

In some embodiments, the conductive additives include polymers. In some embodiments, the polymers include, without limitation, polysulfides, polythiophenes, poly(3,4-ethylenedioxythiophene) polystyrene sulfonate (PDOT-PSS), poly(phenylene sulfide), polyphenylenes, polypyrroles, polyanilines, and combinations thereof.

The conductive additives of the present disclosure can become associated with porous carbon materials in various manners. For instance, in some embodiments, the conductive additives of the present disclosure can become associated with porous carbon materials in a uniform manner. In some embodiments, the conductive additives can become associated with surfaces of the porous carbon materials. In some embodiments, the conductive additives can become uniformly coated on a surface of the porous carbon materials. In some embodiments, the conductive additives can become infiltrated within the pores of the porous carbon materials. Additional modes of associations can also be envisioned.

Association of Porous Carbon Materials With Metals and Conductive Additives

Various methods may be utilized to associate porous carbon materials with metals and conductive additives. For instance, in some embodiments, the associations can occur by filtration, ultrafiltration, coating, spin coating, spraying, spray coating, patterning, mixing, blending, thermal activation, electro-deposition, electrochemical deposition, doctor-blade coating, screen printing, gravure printing, direct write printing, inkjet printing, mechanical pressing, melting, and combinations thereof.

In some embodiments, the associations can occur by electrochemical deposition. In some embodiments, the associations can occur by mixing. In some embodiments, the associations can occur by coating.

The association of porous carbon materials with metals and conductive additives can also occur at various times. For instance, in some embodiments, the associations can occur during electrode fabrication. In some embodiments, the associations can occur after electrode fabrication.

In some embodiments, the association of porous carbon materials with metals can occur in situ during electrode operation. For instance, in some embodiments, electrodes that contain the porous carbon materials of the present disclosure are placed in an electric field that contains metals. Thereafter, the metals become associated with the porous carbon materials during the application of the electric field.

In some embodiments, the association of porous carbon materials with metals occurs by melting a metal (e.g., a pure metal, such as lithium) over a surface of porous carbon materials. Thereafter, the metals can become associated with the porous carbon materials during the wetting of the porous carbon materials by the liquid metal.

In some embodiments, the association of porous carbon materials with metals occurs by electro-depositing a metal (e.g., a pure metal or a metal-containing solid material, such as lithium or lithium-based materials) over a surface of porous carbon materials. Thereafter, the metals can become associated with the porous carbon materials during the electro-deposition. In some embodiments, the metal may be dissolved in an aqueous or organic electrolyte during electro-deposition.

Substrates

In some embodiments, the porous carbon materials of the present disclosure may also be associated with a substrate (e.g., substrate 26 in FIG. 1B). In some embodiments, the substrate serves as a current collector. In some embodiments, the substrate and the porous carbon material serve as a current collector.

Various substrates may be utilized in the electrodes of the present disclosure. For instance, in some embodiments, the substrate includes, without limitation, nickel, cobalt, iron, platinum, gold, aluminum, chromium, copper, magnesium, manganese, molybdenum, rhodium, ruthenium, silicon, tantalum, titanium, tungsten, uranium, vanadium, zirconium, silicon dioxide, aluminum oxide, boron nitride, carbon, carbon-based substrates, diamond, alloys thereof, and combinations thereof. In some embodiments, the substrate includes a copper substrate. In some embodiments, the substrate includes a nickel substrate.

In some embodiments, the substrate includes a carbon-based substrate. In some embodiments, the carbon-based substrate includes, without limitation, graphitic substrates, graphene, graphite, buckypapers (e.g., papers made by filtration of carbon nanotubes), carbon fibers, carbon fiber papers, carbon papers (e.g., carbon papers produced from graphene or carbon nanotubes), graphene papers (e.g., graphene papers made by filtration of graphene or graphene oxide with subsequent reduction), carbon films, graphene films, graphoil, metal carbides, silicon carbides, and combinations thereof.

The porous carbon materials of the present disclosure may be associated with a substrate in various manners. For instance, in some embodiments, the porous carbon materials of the present disclosure are covalently linked to the substrate. In some embodiments, the porous carbon materials of the present disclosure are substantially perpendicular to the substrate. Additional arrangements can also be envisioned.

Electrode Structures and Properties

The electrodes of the present disclosure can have various structures. For instance, in some embodiments, the electrodes of the present disclosure are in the form of films, sheets, papers, mats, scrolls, conformal coatings, and combinations thereof. In some embodiments, the electrodes of the present disclosure have a three-dimensional structure.

The electrodes of the present disclosure can also have various metal to carbon ratios. For instance, in some embodiments, the electrodes of the present disclosure have metal to carbon ratios of about 1:1. In some embodiments, the electrodes of the present disclosure have metal to carbon ratios of about 1:2. In some embodiments, the electrodes of the present disclosure have metal to carbon ratios of about 1:5.

The electrodes of the present disclosure can serve various functions. For instance, in some embodiments, the electrodes of the present disclosure can serve as an anode. In some embodiments, the electrodes of the present disclosure can serve as a cathode.

Different components of the electrodes of the present disclosure can serve various functions. For instance, in some embodiments, the porous carbon materials serve as the active material of the electrodes (e.g., active materials of cathodes and anodes). In some embodiments, the porous carbon materials serve as a host material (e.g., a host material for lithium plating). In some embodiments, the porous carbon materials serve as a current collector. In additional embodiments, the metals serve as the electrode active material while the porous carbon materials serve as a current collector or a host material. In more specific embodiments, the metals serve as the electrode active material while the porous carbon materials serve as a host material.

In some embodiments, porous carbon materials serve as a current collector in conjunction with a substrate (e.g., a copper substrate). In some embodiments, the porous carbon materials of the present disclosure also serve to suppress dendrite formation.

The electrodes of the present disclosure can have various advantageous properties. For instance, in some embodiments, the electrodes of the present disclosure have high specific capacities. In some embodiments, the electrodes of the present disclosure have specific capacities of more than about 400 mAh/g. In some embodiments, the electrodes of the present disclosure have specific capacities of more than about 2,000 mAh/g. In some embodiments, the electrodes of the present disclosure have specific capacities ranging from about 1,000 mAh/g to about 5,000 mAh/g. In some embodiments, the electrodes of the present disclosure have specific capacities ranging from about 3,000 mAh/g to about 5,000 mAh/g. In some embodiments, the electrodes of the present disclosure have specific capacities of more than about 3,500 mAh/g.

In some embodiments, the electrodes of the present disclosure retain more than 90% of their specific capacity after 500 cycles. In some embodiments, the electrodes of the present disclosure retain more than 95% of their specific capacity after 500 cycles.

The electrodes of the present disclosure can also have high areal capacities. For instance, in some embodiments, the electrodes of the present disclosure have areal capacities ranging from about 0.1 mAh/cm² to about 20 mAh/cm². In some embodiments, the electrodes of the present disclosure have areal capacities ranging from about 0.4 mAh/cm² to about 10 mAh/cm². In some embodiments, the electrodes of the present disclosure have areal capacities of at least about 9 mAh/cm².

The electrodes of the present disclosure can also have high coulombic efficiencies. For instance, in some embodiments, the electrodes of the present disclosure have coulombic efficiencies of more than about 90% after more than 100 cycles. In some embodiments, the electrodes of the present disclosure have coulombic efficiencies of more than about 95% after more than 100 cycles.

In some embodiments, the electrodes of the present disclosure have coulombic efficiencies of more than about 80% after more than 100 cycles. In some embodiments, the electrodes of the present disclosure have coulombic efficiencies of more than about 80% after more than 500 cycles. In some embodiments, the electrodes of the present disclosure have coulombic efficiencies of more than about 70% after more than 100 cycles. In some embodiments, the electrodes of the present disclosure have coulombic efficiencies of more than about 70% after more than 700 cycles.

Incorporation into Energy Storage Devices

The methods of the present disclosure can also include a step of incorporating the electrodes of the present disclosure as a component of an energy storage device. Additional embodiments of the present disclosure pertain to energy storage devices that contain the electrodes of the present disclosure.

The electrodes of the present disclosure can be utilized as components of various energy storage devices. For instance, in some embodiments, the energy storage device includes, without limitation, capacitors, batteries, photovoltaic devices, photovoltaic cells, transistors, current collectors, and combinations thereof.

In some embodiments, the energy storage device is a capacitor. In some embodiments, the capacitor includes, without limitation, lithium-ion capacitors, super capacitors, ultra capacitors, micro supercapacitors, pseudo capacitors, two-electrode electric double-layer capacitors (EDLC), and combinations thereof.

In some embodiments, the energy storage device is a battery (e.g., battery 30 in FIG. 1C). In some embodiments, the battery includes, without limitation, rechargeable batteries, non-rechargeable batteries, micro batteries, lithium-ion batteries, lithium-sulfur batteries, lithium-air batteries, sodium-ion batteries, sodium-sulfur batteries, sodium-air batteries, magnesium-ion batteries, magnesium-sulfur batteries, magnesium-air batteries, aluminum-ion batteries, aluminum-sulfur batteries, aluminum-air batteries, calcium-ion batteries, calcium-sulfur batteries, calcium-air batteries, zinc-ion batteries, zinc-sulfur batteries, zinc-air batteries, and combinations thereof. In some embodiments, the energy storage device is a lithium-ion battery.

The electrodes of the present disclosure can be utilized as various components of energy storage devices. For instance, in some embodiments, the electrodes of the present disclosure are utilized as a cathode in an energy storage device (e.g., cathode 32 in battery 30, as illustrated in FIG. 1C). In some embodiments, the electrodes of the present disclosure are utilized as anodes in an energy storage device (e.g., anode 36 in battery 30, as illustrated in FIG. 1C).

In some embodiments, the electrodes of the present disclosure are utilized as an anode in an energy storage device. In some embodiments, the anodes of the present disclosure may be associated with various cathodes. For instance, in some embodiments, the cathode is a transition metal compound. In some embodiments, the transition metal compound includes, without limitation, LiₓCoO₂, LiₓFePO₄, LiₓNiO₂, LiₓMnO₂, LiₐNi_{b}Mn_{c}Co_{d}O₂, LiₐNi_{b}Co_{c}Al_{d}O₂, NiO, NiOOH, and combinations thereof. In some embodiments, integers a, b, c, d, and x are more than 0 and less than 1.

In some embodiments, cathodes that are utilized along with the anodes of the present disclosure include sulfur. In some embodiments, the sulfur-containing cathode includes a sulfur/carbon black cathode. In more specific embodiments, the sulfur-containing cathode includes uGil-GNR-S composites.

In some embodiments, the cathode includes oxygen, such as dioxygen, peroxide, superoxide, and combinations thereof. In some embodiments, the cathode contains metal oxides, such as metal peroxides, metal superoxides, metal hydroxides, and combinations thereof. In some embodiments, the cathode includes lithium cobalt oxide.

In some embodiments, the energy storage devices that contain the electrodes of the present disclosure may also contain electrolytes (e.g., electrolytes 34 in battery 30, as illustrated in FIG. 1C). In some embodiments, the electrolytes include, without limitation, non-aqueous solutions, aqueous solutions, salts, solvents, additives, composite materials, and combinations thereof. In some embodiments, the electrolytes include, without limitation, lithium hexafluorophosphate (LiPF6), lithium (trimethylfluorosulfonyl) imide (LITFSI), lithium (fluorosulfonyl) imide (LIFSI), lithium bis(oxalate)borate (LiBOB), hexamethylphosphoustriamide (HMPA), and combinations thereof. In some embodiments, the electrolytes are in the form of a composite material. In some embodiments, the electrolytes include solvents, such as ethylene carbonate, diethyl carbonate, dimethyl carbonate, ethyl methyl carbonate, 1,2-dimethoxyl methane, and combinations thereof.

In some embodiments, the energy storage devices of the present disclosure are incorporated into an electronic device. In some embodiments, the electronic device includes, without limitation, mobile communication devices, wearable electronic devices, wireless sensor devices, electric cars, electric motorcycles, drones, cordless power tools, cordless appliances, and combinations thereof.

Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Ultrahigh Surface Area Porous Carbon Supported Lithium for High-Performance Lithium-ion Batteries

In this Example, Applicants used a porous carbon material derived from untreated gilsonite (uGil, a type of asphalt) as the host material for lithium (Li) plating. As revealed by scanning electron microscopy (SEM), the large surface area of the porous carbon ensured that Li would be deposited on the surface of porous carbon materials instead of forming dendritic structures Next, graphene nanoribbons (GNRs) were added to enhance the conductivity of the host material, which was desired for working at high densities. The produced anodes (i.e., uGil-GNR-Li anodes) had remarkable rate performance from 5 A/g_{Li} (1.3C) to 40 A/g_{Li} (10.4C) with a coulombic efficiency above 96%. Moreover, stable cycling of the uGil-GNR-Li anodes was achieved for more than 500 cycles at 5 A/g_{Li}. In addition, the areal capacity of the uGil-GNR-Li anodes reached up to 9.4 mAh/cm² at a discharging/charging rate of 20 mA/cm².

As such, the uGil-GNR-Li anode can find applications in portable and rapid charge/discharge devices. Moreover, the preparation of the uGil-GNR-Li anodes is highly cost-effective because the uGil starting material is widely accessible and inexpensive.

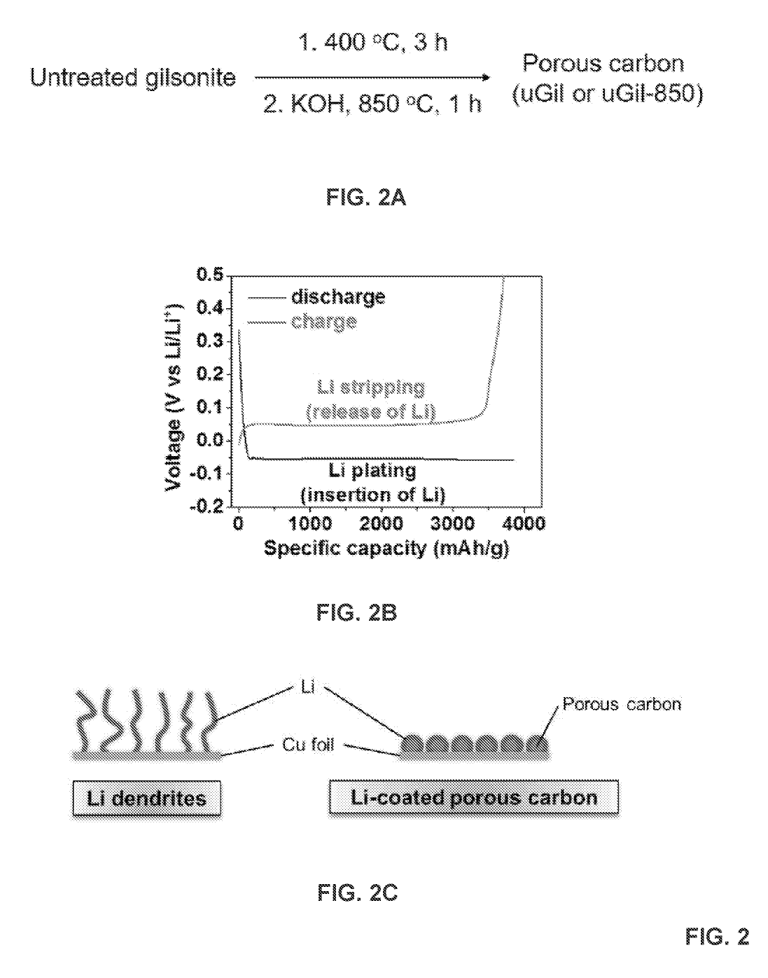

The porous carbon material was generated from uGil through potassium hydroxide (KOH) activation after removing most of the oil contents at 400° C. (FIG. 2A). Also see PCT/US2016/048430. The activation process created a porous carbon material with a surface area of more than 4,000 m²/g. Thereafter, the porous carbon material was coated on copper foil current collectors by a slurry method. GNRs were also added to the slurry in order to improve the conductivity of the porous carbon materials. Since the synthesis of porous carbon materials did not involve any direct growth of materials on a substrate, the mass loading was not significantly limited by the area on which the host material was loaded.

The uGil-GNR-Li anode was prepared in coin cells by electrochemical deposition of Li (FIG. 2B). 4 M Lithium bis(fluorosulfonyl)imide (LiFSI) in 1,2-dimethoxyethane (DME) was used as the electrolyte. For example, lithiating the electrode at 2.5 mA/cm² for 46 minutes will produce 0.5 mg/cm² Li. When the areal current density or the reaction time increases, the resulting areal density of Li will also increase.

Instead of forming dendrites, which happens when no host material exists (FIG. 2C, left panel), the Li metal formed a thin layer of coating on porous carbon material particles (FIG. 2C, right panel). Without being bound by theory, it is envisioned that an anode where the Li is spread over a large surface area reduces the effective current density between the lithium and the electrolyte and therefore reduces the dendrite formation.

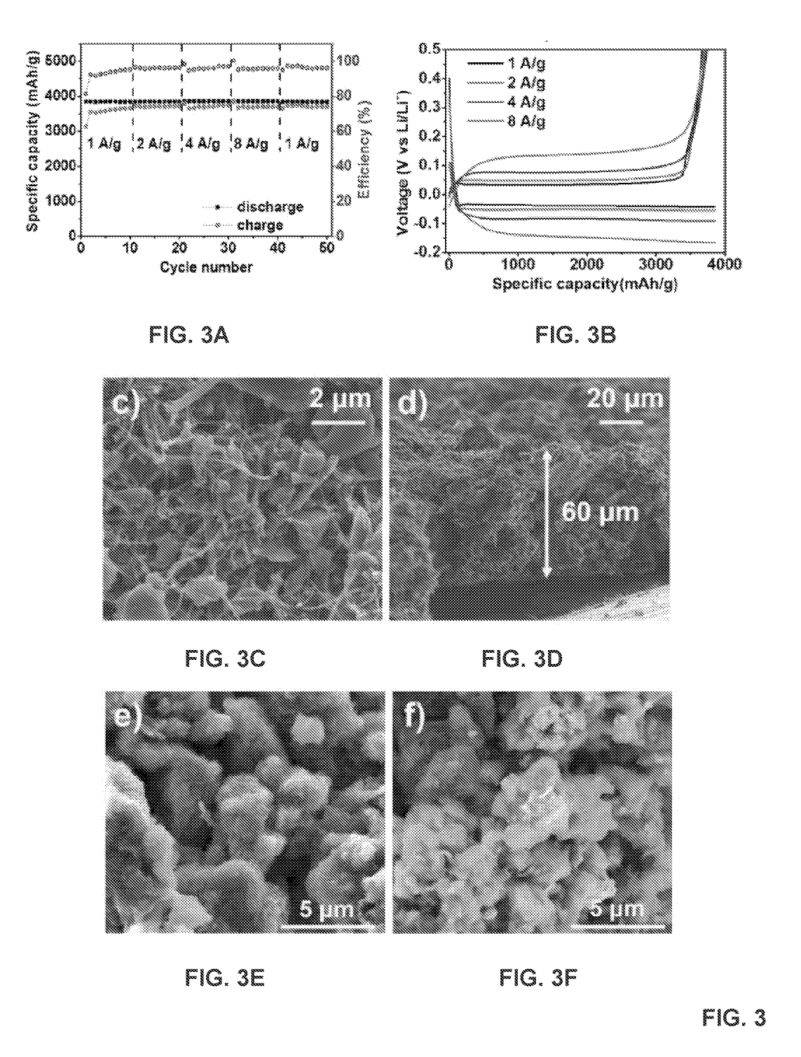

The mass loading of uGil-GNR on Cu foils per area was about 2.5 mg/cm², which was relatively high as to provide a larger surface area for lithiation. The morphology of the uGil-GNR electrode is shown by SEM images in FIGS. 3C (top view) and 3D (side view). The GNRs with high aspect ratio were well mixed with porous carbon particles at a thickness of 60 μm, which ensured the conductivity throughout the electrode. The thickness could be adjusted by changing the mass loading of GNR-uGil per area.

The uGil-GNR-Li anode showed high coulombic efficiency in a half cell when assembled with Li foils. The Li:C ratio was set at 1:5 by controlling the time of Li plating. The overall coulombic efficiency stayed above 95.4% with current densities ranging from 1 A/g_{C} (per gram of carbon) to 8 A/g_{C} (FIG. 3A). A high current density of 8 A/g_{C} was used from cycle 31 to cycle 40, which corresponded to 40 A/g_{Li} (per gram of Li) and 10.4C for Li metal. Moreover, a stable efficiency above 96.0% was still observed (FIG. 3A).

The discharge/charge profiles are shown in FIG. 3B, where voltage plateaus for Li stripping are located at 35 mV, 49 mV, 78 mV and 139 mV for 1 A/g_{C}, 2 A/g_{C}, 4 A/g_{C} and 8 A/g_{C}. The increasing voltage plateau likely resulted from elevated internal resistance as the current increased.

In order to demonstrate that Li metal was deposited on the surface of uGil-GNR without the formation of dendrites, SEM was used to study the morphology of the anode after cycling. Two anodes were first lithiated and delithiated for 30 cycles at 2 A/g, one of which was then lithiated again while the other was not. SEM was performed after the electrodes were taken out of the coin cells and washed with DME to remove the electrolyte on the surface.

The SEM image of a lithiated sample in FIG. 3E shows that Li was uniformly coated on uGil-GNR composites without any mossy structures. The SEM image confirms that dendrite formation was successfully suppressed.

The SEM image of a delithiated sample of uGil-GNR composites in FIG. 3F shows a similar porous structure as the lithiated structure. This suggests that morphology change was not significant after delithiation, which helped to keep the high surface area for plating of metallic Li.

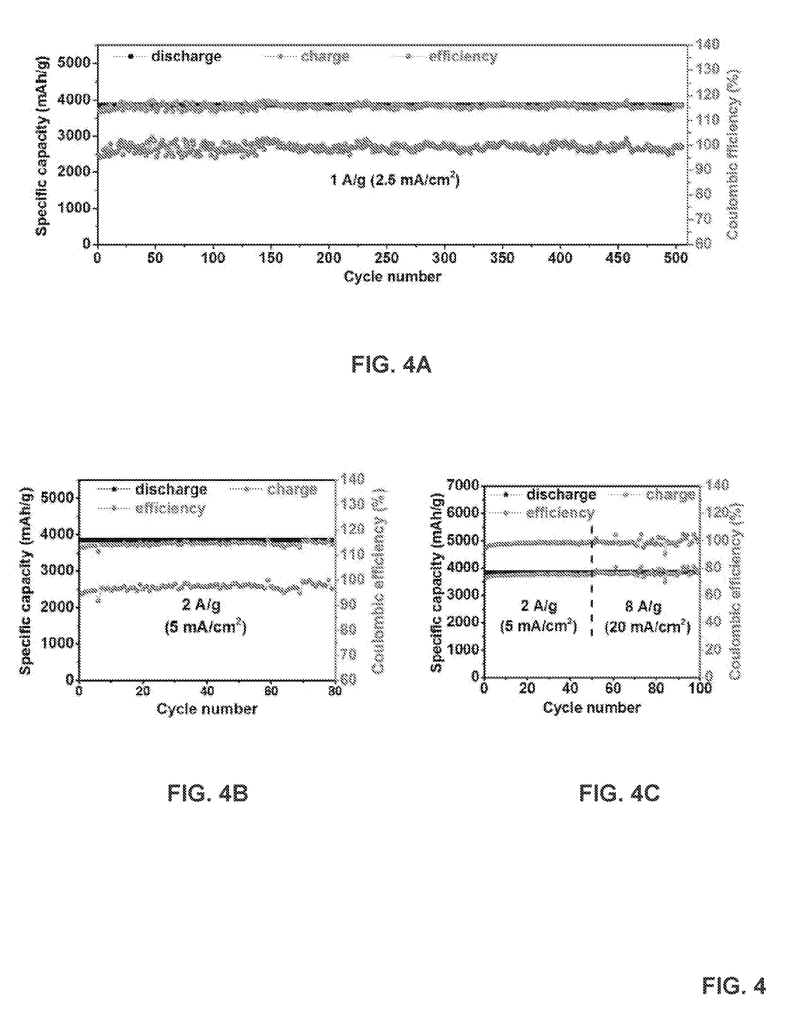

Longer cycles were also tested in half cells in order to study the cycling stability of the uGil-GNR-Li anode. An average Coulombic efficiency of 99.0% was obtained with a very small standard deviation of 1.5% for 505 cycles at 1 A/g_{C} (FIG. 4A). The efficiency became more consistent after about 150 cycles. Without being bound by theory, such consistent efficiencies could be due to reactive species in uGil-GNR being consumed up from the beginning and SEI layers becoming more stable. Efficiencies slightly above 100% were also observed in a handful of cycles, which could be beneficial for long-term use because it repeatedly compensated for the capacity loss accumulated through previous cycles.

The small amount of leftover Li after each Li stripping step was not completely unreactive. As such, the coulombic efficiency did not continue declining. The anode with higher Li loading also maintained high coulombic efficiency as well as good cycling stability.

In order to achieve higher areal capacity, the Li:C ratio was increased from 1:5 to 1:2 (FIG. 4B) and 1:1 (FIG. 4C). Moreover, the anodes still had average coulombic efficiencies of more than 97% with good cycling stability.

When current density was further enhanced to 8 A/g with the Li:C ratio of 1:1 (FIG. 4C), the coulombic efficiency did not show a noticeable decrease on average, although the stability was slightly impaired. The areal capacity for Li:C ratio of 1:5, 1:2 and 1:1 were calculated to be 1.9 mAh/cm², 4.7 mAh/cm², and 9.4 mAh/cm², respectively.

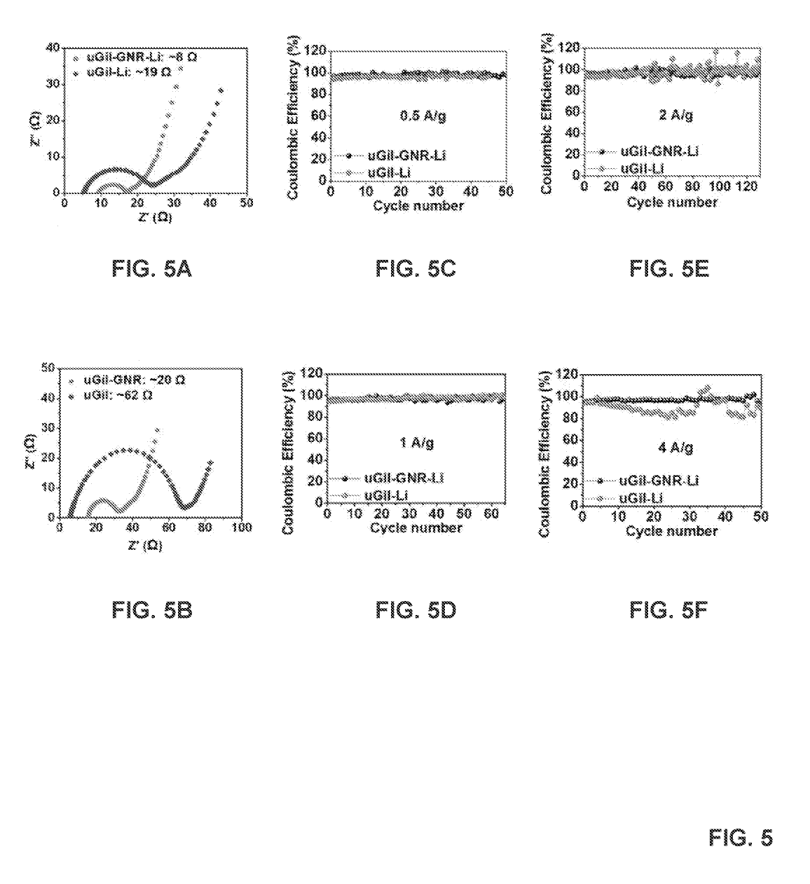

The high surface area of host material uGil was one of the reasons that the coulombic efficiency remained high and stable. GNRs were also demonstrated to be desired for the stabilization of the electrochemical performance by using uGil-Li anodes as the control. The enhanced conductivity was revealed by electrochemical impedance spectroscopy. When assembled with Li foils as the counter electrode, uGil-GNR-Li anodes turned out to have lower internal resistance than uGil-Li anodes, which did not contain GNRs or other conductive additives, in both lithiated and delithiated states (FIGS. 5A-B). The difference in conductivity was not a significant problem at low current densities such as 0.5 A/g_{C} and 1 A/g_{C} (FIGS. 5C-D), given that both uGil-GNR-Li anodes and uGil-Li anodes produced stable coulombic efficiency.

However, the uGil-Li anodes started to show noticeable fluctuation after 40 cycles at 2 A/g_{C} (FIG. 5E). In addition, the efficiency dropped below 90% after only 15 cycles at 4 A/g_{C} (FIG. 5F).

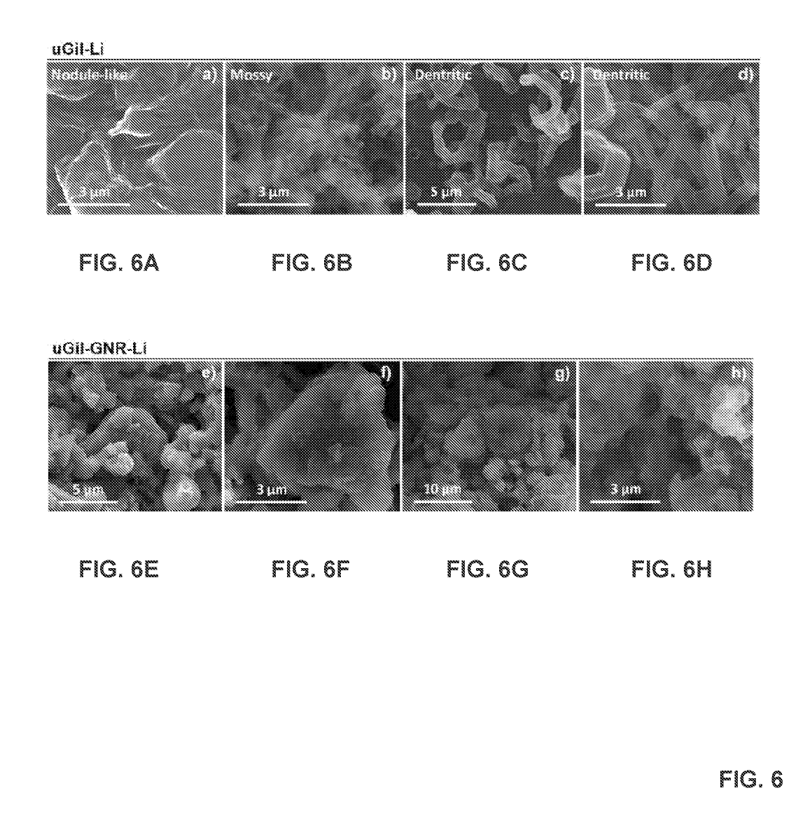

In the SEM images of uGil-Li anodes, mossy and nodule-like Li metal structures were seen when tested at 2 A/g_{C}, which was a sign of uneven distribution of Li (FIGS. 6A-D). When the current density further increased to 4 A/g_{C}, the formation of Li dendrites appeared in the images of uGil-Li anodes. In contrast, no mossy or dendritic structures were apparent in uGil-GNR-Li anodes tested at 2 A/g_{C} and 4 A/g_{C} (FIGS. 6E-H). The aforementioned results indicate that GNRs guaranteed the conductivity needed to prevent Li dendrite growth and capacity/coulombic efficiency degradation, particularly at high current density.

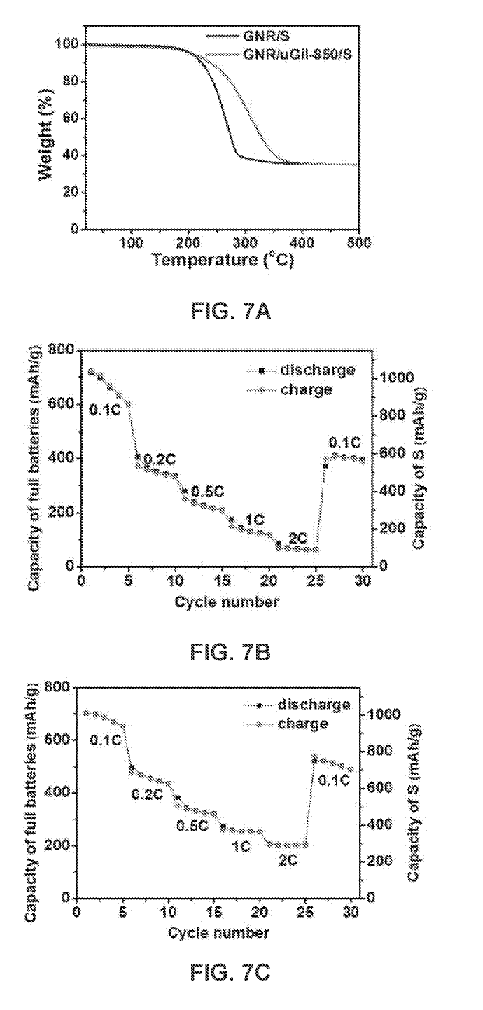

Apart from the anode, uGil-GNR was also combined with sulfur to produce a uGil-GNR-S composite cathode by a melt-diffusion method. The overall sulfur content in the composite was measured to be about 60 wt % by thermogravimetric analysis (TGA). Higher evaporation temperature of sulfur was observed in uGil-GNR-S composites when compared to that of GNR-S composites, which was similar to the behavior of most carbon-sulfur composite materials (FIG. 7A). This implies that a stronger interaction between the uGil and sulfur could exist after annealing, which may be helpful in trapping the sulfur and polysulfide ions and slowing down the capacity loss.

Next, full batteries were assembled using uGil-GNR-Li as the anode and uGil-GNR-S as the cathode. Two different electrolyte solutions were selected: (1) 4 M LiFSI in DME (which was known to be compatible with the uGil-GNR-Li anodes); and (2) 1 M LiFSI and LiNO₃ in DME (which was the regular electrolyte solution for Li—S batteries). Rate performances are shown in FIGS. 7B and 7C. The initial discharge/charge capacity of full batteries at 0.1C were 717/723 mAh/g and 705/702 mAh/g for 4 M and 1 M electrolyte, respectively. The 1 M electrolyte produced more stable and higher capacity, especially at high discharging/charging rates, although the initial capacity was slightly lower.

In sum, Applicants have developed a uGil-GNR composite material as a host material for Li plating that evidently suppresses Li dendrite formation at current densities from 5 A/g_{Li} (1.3C) to 40 A/g_{Li} (10.4C). The coulombic efficiency stayed above 96% and remained stable for more than 500 cycles at 5 A/g_{Li}. An areal capacity of 9.4 mAh/cm² was obtained with a Li:C ratio of 1:1 at a highest current density of 20 mA/cm². SEM images of uGil-GNR-Li anodes after cycling did not show the formation of any dendritic Li. However, uGil-Li anodes with the lack of the conductive additives showed dendritic Li formation. Such high coulombic efficiencies, areal capacities and discharging/charging rates indicate that uGil-GNR-Li anodes can be suitable for applications in micro and rapid charge/discharge devices. Moreover, the combination of uGil-GNR-Li anodes with uGil-GNR-S cathodes can lead to full batteries based on uGil, which is only derived from asphalt.

### EXAMPLE 1.1

### Synthesis of Graphene Nanoribbons (GNRs)

Multi-walled carbon nanotubes (MWCNTs, 100 mg, 8.3 mmol, from EMD-Merck) were added to a dry 100 mL round-bottom flask with a magnetic stir bar. The flask was transferred into a N₂ glovebox where 1,2-dimethoxyethane (35 mL) and liquid Na/K alloy (0.2 mL, molar ratio of Na:K=2:9) was added. The flask was sealed and transferred out of the glovebox and ultrasonicated for 5 minutes before stirring at room temperature for 3 days. Methanol (20 mL) was used to quench the reaction. The reaction mixture was then stirred for 10 minutes before it was filtered over a 0.45 μm pore size PTFE membrane and washed in the sequence of tetrahydrofuran (THF) (100 mL), i-PrOH (100 mL), H₂O (100 mL), i-PrOH (100 mL), THF (100 mL) and Et₂O (10 mL). The product was dried in vacuum (˜10⁻² mbar) for 24 hours.

### EXAMPLE 1.2

### Synthesis of Porous Carbon Materials (uGil)

Untreated gilsonite (Versatrol HT) was pretreated at 400° C. under Ar for 3 hours. The pretreated gilsonite was ground with KOH in a mortar. The mass ratio of KOH to pretreated gilsonite was 4:1. The mixture was then heated at 850° C. for 15 minutes, followed by filtration and washing with water until pH was ˜7. The product was dried at 110° C. for 12 hours.

### EXAMPLE 1.3

### Preparation of uGil-GNR Electrodes and Electrochemical Measurements

GNRs, uGil and polyvinylidene difluoride (PVDF; Alfa Aesar) were mixed in a mortar with a mass ratio of 4.5:4.5:1. N-methyl-2-pyrrolidone (NMP; Sigma-Aldrich) was added to form a slurry, which was then coated on a Cu foil substrate and dried in vacuum at 50° C. overnight.

Control experiments including GNR electrodes were prepared in the same way. Electrochemical tests were performed using CR2032 coin cells with lithium metal foils as the counter electrode. The electrolyte was 4 M LiFSI dissolved in DME and the separator was Celgard 2045 membranes. The capacity was evaluated based on the mass of lithium calculated from the time-control discharging lithiation process with m_{Li}=I×t×M_{Li}/F, where I is the discharging current, t is the discharging time, M_{Li} is the molecular weight of Li, and F is the Faraday constant (96485 C/mol). EIS was performed on a CHI 608D workstation (CH Instruments).

### EXAMPLE 1.4

### Preparation of uGil-GNR-S Composites

GNRs, uGil and sulfur were mixed in a mortar with a mass ratio of 1:1:6. Next, the mixture was annealed at 155° C. for 10 hours and 250° C. for 10 minutes.

### EXAMPLE 1.5

### Preparation and Characterization of Full Batteries

The uGil-GNR-S composite was mixed with PVDF in a mortar with a mass ratio of 9:1. NMP was added to form a slurry which was then coated on Al or stainless steel foil substrate and dried in vacuum at 40° C. overnight. Electrochemical tests were performed using CR2032 coin cells with lithium metal foils as the counter electrode. The electrolyte was 1 M LiFSI with 0.5 M LiNO₃ in DME. The separator was a Celgard 2045 membrane. The capacity was evaluated based on the mass of sulfur measured by TGA. The lithiated uGil-GNR-Li anode, which was taken out from the coin cell after Li plating, was used instead of Li metal foils for assembly of full batteries with the same protocol.

### EXAMPLE 1.6

### Characterization Equipment

SEM images were recorded on a JEOL 6500 scanning electron microscope. TGA was performed on a Q-600 Simultaneous TGA/DSC (from TA instrument) under 100 mL·min⁻¹ Ar flow at a heating rate of 10° C.·min ⁻¹.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1-54. (canceled)

55. An energy-storage device comprising:
an anode; and
a cathode;
at least one of the anode and the cathode including an electrode having:
a conductive substrate;
a layer of porous carbon material particles on the conductive substrate, the layer of the porous carbon material particles having a surface of a surface area greater than 2,000 square meters per gram; and
a metal film on the surface.

56. The energy-storage device of claim 55, wherein the metal film consists essentially of lithium.

57. The energy-storage device of claim 56, wherein the lithium has a lithium mass, the layer of the porous carbon material particles has a carbon mass, and the ratio of the lithium mass to the carbon mass is at least one-to-two.

58. The energy-storage device of claim 55, wherein the metal film is uniform.

59. The energy-storage device of claim 55, wherein the porous carbon material of the particles is selected from the group consisting of asphalt-based porous carbon materials, asphaltene-based porous carbon materials, anthracite-based porous carbon materials, coal-based porous carbon materials, coke-based porous carbon materials, biochar-based porous carbon materials, carbon black-based porous carbon materials, coal-based porous carbon materials, oil product-based porous carbon materials, bitumen-based porous carbon materials, tar-based porous carbon materials, pitch-based porous carbon materials, polymer-based porous carbon materials, protein-based porous carbon materials, carbohydrate-based porous carbon materials, cotton-based porous carbon materials, fat-based porous carbon materials, waste-based porous carbon materials, graphite-based porous carbon materials, melamine-based porous carbon materials, wood-based porous carbon materials, porous graphene, porous graphene oxide, high surface area active carbons, and combinations thereof.

60. The energy-storage device of claim 55, further comprising sulfur diffused within the layer of the porous carbon material particles.

61. The energy-storage device of claim 55, further comprising conductive additives between the porous carbon material particles.

62. The energy-storage device of claim 61, wherein the conductive additives comprise graphene.

63. The energy storage device of claim 62, wherein the conductive additives comprise graphene nanoribbons mixed with the porous carbon material particles.

64. The energy-storage device of claim 55, the layer of porous carbon material particles prepared by a process comprising mixing a carbon source with potassium hydroxide to create a carbon mixture.

65. The energy-storage device of claim 64, the process further comprising heating the carbon mixture.

66. The energy-storage device of claim 64, the process further comprising removing oil from the carbon source before the mixing.

67. The energy-storage device of claim 55, wherein the porous carbon material particles comprise a plurality of micropores and mesopores.

68. A method for making an electrode for an energy-storage device, the method comprising:
mixing carbon with potassium hydroxide to produce a carbon mixture;
heating the carbon mixture to activate the carbon;
applying the activated carbon to a conductive substrate; and
coating the activated carbon with a metal film.

69. The method of claim 68, further comprising heating a carbon source comprised of oil to remove the oil from the carbon source and leave the carbon.

70. The method of claim 68, wherein the activated carbon has a surface area greater than 2,000 square meters per gram.

71. The method of claim 70, wherein the surface area is greater than 4,000 square meters per gram.

72. The method of claim 68, further comprising adding a conductive additive to the carbon mixture before applying the activated carbon to the conductive substrate.

73. The method of claim 72, wherein the conductive additive includes graphene nanoribbons.

74. The method of claim 68, further comprising grinding the carbon before the mixing.

75. The method of claim 68, wherein the coating comprises forming a slurry of the activated carbon.

76. The method of claim 68, wherein the metal film comprises lithium metal.

77. The method of claim 68, further comprising obtaining the carbon from a material selected from the group consisting of asphalt-based porous carbon materials, asphaltene-based porous carbon materials, anthracite-based porous carbon materials, coal-based porous carbon materials, coke-based porous carbon materials, biochar-based porous carbon materials, carbon black-based porous carbon materials, coal-based porous carbon materials, oil product-based porous carbon materials, bitumen-based porous carbon materials, tar-based porous carbon materials, pitch-based porous carbon materials, polymer-based porous carbon materials, protein-based porous carbon materials, carbohydrate-based porous carbon materials, cotton-based porous carbon materials, fat-based porous carbon materials, waste-based porous carbon materials, graphite-based porous carbon materials, melamine-based porous carbon materials, wood-based porous carbon materials, porous graphene, porous graphene oxide, high surface area active carbons, and combinations thereof.
